(19) United States
(12) Patent Application Publication
(10) Pub. No.: US 2015/0199785 A1
(43) Pub. Date: Jul. 16, 2015

(54) UNMANNED OPERATION MANAGEMENT APPARATUS FOR ACCEPTING MAIL AND CONTROL METHOD THEREOF

(71) Applicant: Electronics and Telecommunications Research Institute, Daejeon (KR)

(72) Inventor: Moon Sung PARK, Daejeon (KR)

(21) Appl. No.: 14/302,010

(22) Filed: Jun. 11, 2014

(30) Foreign Application Priority Data
Jan. 14, 2014 (KR) 10-2014-0004436

(51) Int. Cl. G06Q 50/32; G06Q 10/08

(52) U.S. Cl. CPC G06Q 50/32; G06Q 10/083; G06Q 2250/50

(57) ABSTRACT

Provided are an unmanned operation management apparatus for accepting mail and a control method thereof. The unmanned operation management apparatus and control method calculate postage depending on a size and a selected service and when mail for which the calculated postage is paid is inserted into a common acceptance box and the common acceptance box is filled with pieces of mail, allow a collection worker to collect the mail of the filled common acceptance box, so as to automatically accept and process a user's mail. A mail size that is a reference for calculating postage can be more efficiently and accurately measured, and by configuring and operating the mail assortment common acceptance box, a mail collecting work can be easily performed. Moreover, when the common acceptance box is full, mail is accepted by using the spare delivery box, thereby preventing a problem caused by a lack of an acceptance box.

### CROSS-REFERENCE TO RELATED APPLICATIONS

This application claims priority under 35 U.S.C. §119 to Korean Patent Application No. 10-2014-0004436, filed on Jan. 14, 2014, the disclosure of which is incorporated herein by reference in its entirety.

### TECHNICAL FIELD

The present invention relates to an unmanned operation management apparatus for accepting mail and a control method thereof, and more particularly, to an apparatus and a method, which automatically accept and process mail.

### BACKGROUND

A prior patent document (Korean Patent Publication No. 10-2003-0004975) relates to an intelligent unmanned mail acceptance system that executes, for post offices, stamp sale work and various mail acceptance works, such as general mails, registered mails, express mails, and international mails, and public relations work by using high-tech image recognition and mechatronics technology. A customer inserts a general mail or a small parcel mail (which is desired to send) through an automatic door, and when the customer selects a desired kind of post service by using a touch screen, by using two CCD cameras based on a stereo type, the intelligent unmanned mail acceptance system automatically measures a weight and size of mail, calculates postage on the basis of the measured weight and size of the mail, and displays the customer's selections and the calculated postage to the customer.

When the customer pays for the displayed postage with coins, bills, or a card, the intelligent unmanned mail acceptance system printing-outputs a label that indicates a stamp substitute charge stamp, an express mail, or a registered mail. When the customer attaches the printing-output materials to the mail and again inserts the main with the printing-output materials attached thereto, the mail is automatically and finally inserted into a mail storage box included in the intelligent unmanned mail acceptance system.

The intelligent unmanned mail acceptance system is used as a method in which a weight of mail is measured by a general scale, postage is calculated based on the measured weight, and the mail is accepted.

Moreover, the intelligent unmanned mail acceptance system measures a length of small mail. In this case, a width value and height value of an upper surface of mail are calculated based on four corner points by using two or more image cameras, for measuring a size of the mail. Also, when an image of a side surface is accurately acquired, a calculation result of a height value is provided.

A body of an intelligent unmanned mail acceptance apparatus has a size in which a front width is 1,900 mm, a front height is 1,800 mm, a front and rear depth is 800 mm, and has a self-supporting structure which is configured with three parts such as a left part, a central part, and a right part.

Considering the width of total 1,900 mm, a width and height of a central part, and a size of a mail slot, the intelligent unmanned mail acceptance system receives only small mails (depth of about 270 mm*width of about 180 mm*height of about 150 mm), and two or more cameras are installed in an upper space for measuring a height of mail.

Moreover, the intelligent unmanned mail acceptance system needs a large space for installing two or more cameras used to measure a size of mail. Also, since the intelligent unmanned mail acceptance system combines acquired images to calculate a size of mail, much time is expended, and a large error of a size measurement result occurs due to the size of the mail and qualities of the acquired images. For this reason, the intelligent unmanned mail acceptance system cannot accurately measure sizes of various mails in a small space.

A prior patent document (Korean Patent Publication No. 10-2002-0042062) discloses an intelligent unmanned parcel sending apparatus and an operating method thereof, which automatically process an operation of providing a parcel sending service. A sender processes an overall operation of sending a parcel even without the help of another user, and the intelligent unmanned parcel sending apparatus is applied to an operation of sending mail or a package similar to a parcel.

The intelligent unmanned parcel sending apparatus is intelligent, and thus provides a sending service through an interaction with a sender in various ways. Since the intelligent unmanned parcel sending apparatus is automatically operated, the intelligent unmanned parcel sending apparatus provides an around-the-clock sending service. Since the intelligent unmanned parcel sending apparatus is network-connected to a central system of a delivery company, the intelligent unmanned parcel sending apparatus determines, in real time, an effective processing method of an inserted parcel at a timing when the parcel is inserted.

Moreover, the intelligent unmanned parcel sending apparatus deals with the central system through an interaction, and connects the central system, a sender, and a receiver over a network, thereby allowing a parcel to be the most efficiently delivered to the receiver. Therefore, the optimized fee system is determined.

However, in the prior patent document (Korean Patent Publication No. 10-2002-0042062), since a method of delivering mail through a delivery device is not accurately specified, it is required to improve a delivery method using the delivery device. Also, since technology for measuring weight and a size necessary for postage determination based on bargaining and an accepted-mail submitting method are not disclosed, improvement is needed.

A prior patent document (Korean Patent Application No. 10-2008-0110135) relates to an unmanned parcel/mail acceptance delivery apparatus which is connected to, on-line, a system server that connects a parcel company, a post office, and a user on-line. The unmanned parcel/mail acceptance delivery apparatus includes a body that includes a plurality of baggage storage parts, an input/output unit that is installed at the body and inputs/outputs parcel and mail-related information, an invoice output unit that outputs, as a sticker-type invoice, the parcel and mail-related information which is input by the input/output unit, and a control unit that includes an unmanned parcel/mail acceptance delivery program, and transmits, in real time, the parcel and mail-related information (which is input by the input/output unit) to the system server.

In receiving a parcel/mail, the unmanned parcel/mail acceptance delivery apparatus receives an electronic signature of an addressee by using a reading unit. In the unmanned parcel/mail acceptance delivery apparatus, an authentication method based on a signet/signature is applied as a method of authenticating a receiver, a method of inputting baggage sender information and inputting addressee information is provided, and the sticker-type invoice is output. The unmanned parcel/mail acceptance delivery apparatus includes an operation, which transmits parcel/mail-related information, and an operation that senses a weight and size of baggage and stores the sensed information. Also, the unmanned parcel/mail acceptance delivery apparatus includes an operation in which a management server compares a mobile phone number of a customer by using a sender identification service, an operation that informs a delivery result by using the mobile phone number, and an operation that, when an authentication of an addressee itself is normally completed, opens the baggage storage part included in the unmanned parcel/mail acceptance delivery apparatus to allow the addressee to receive baggage.

In the unmanned parcel/mail acceptance delivery apparatus, an operation of comparing a mobile phone number is needed for authenticating a customer whenever sending of mail is requested. The unmanned parcel/mail acceptance delivery apparatus outputs an invoice for collected content, but when collecting pieces of accepted mail, it is required to transfer sending information to a server, which provides a mail sending service, without additionally outputting the sending information.

### SUMMARY

Accordingly, the present invention provides an unmanned operation management apparatus for accepting mail and a control method thereof, which calculate postage depending on a size and a selected service and when mail for which the calculated postage is paid is inserted into a common acceptance box and the common acceptance box is filled with pieces of mail, allow a collection worker to collect the mail of the filled common acceptance box, so as to automatically accept and process a user's mail.

The present invention also provides an unmanned operation management apparatus for accepting mail and a control method thereof, which allow a user to search for and use a registered address list in accepting mail when the user is a member, for supporting a simplification of an acceptance information input.

The present invention also provides an unmanned operation management apparatus for accepting mail and a control method thereof, which measure at least one of a weight and size of mail, calculate postage based on the measured result information, and automatically assign a common acceptance box depending on a mail service selection result and the measured mail size, in an operation of accepting the mail.

The present invention also provides an unmanned operation management apparatus for accepting mail and a control method thereof, which generate takeover information of mail which is to be collected, in an operation of collecting mail, and when accepted mail does not match collected mail, prevent lost/accepted mail from being omitted through a 1:1 comparison.

The present invention also provides an unmanned operation management apparatus for accepting mail and a control method thereof, which notify an operating manager of information about an operating error and information, such as states of consumable goods (used by a user) and an insufficient balance state, when the operating error occurs.

In one general aspect, an unmanned operation management apparatus for accepting mail includes: an integration control unit configured to acquire size information of mail by using a reflective plate and a plurality of sensors which are respectively installed at predetermined positions in parallel correspondence with the reflective plate; and an acceptance/delivery integrator operation management unit configured to calculate postage, based on the acquired size information of the mail and main acceptance information input by a user, wherein the integration control unit settles for the mail according to the calculated postage, assigns a mail common acceptance box according to whether boxes are full, and allow the mail to be inserted into the assigned mail common acceptance box.

In another general aspect, a method of controlling an unmanned operation management apparatus for accepting mail includes: acquiring size information of mail by using a reflective plate and a plurality of sensors which are respectively installed at predetermined positions in parallel correspondence with the reflective plate; calculating postage of the mail, based on the acquired size information; and settling for the calculated postage of the mail, and allowing the mail to be inserted into an assigned mail common acceptance box.

Other features and aspects will be apparent from the following detailed description, the drawings, and the claims.

### BRIEF DESCRIPTION OF THE DRAWINGS

FIG. 1 is a diagram for describing an unmanned operation management apparatus for accepting mail according to an embodiment of the present invention.

FIGS. 2A and 2B are diagrams for describing a mail distribution system according to an embodiment of the present invention.

FIG. 3 is a diagram for describing an acceptance/delivery integrator operation management unit according to an embodiment of the present invention.

FIGS. 4A and 4B are a diagram for describing an integration control unit according to an embodiment of the present invention.

FIG. 5 is a diagram for describing an ordinary mail common acceptance box according to an embodiment of the present invention.

FIG. 6 is a diagram for describing a configuration of a sensor according to an embodiment of the present invention.

FIG. 7 is a diagram for describing a common acceptance box and a parcel delivery box which have an ordinary registration and parcel-3 size or less according to an embodiment of the present invention.

FIG. 8 is a diagram for describing a common acceptance box and a parcel delivery box which have a parcel-4 size or more according to an embodiment of the present invention.

FIG. 9 is a flowchart for describing a method of calculating a length of a top of mail from an acquired mail image according to an embodiment of the present invention.

FIGS. 10A and 10B are a flowchart for describing a mail accepting method according to an embodiment of the present invention.

FIGS. 11A and 11B are a flowchart for describing a method of calculating a mail acceptance fee and providing an acceptance condition check result, according to an embodiment of the present invention.

FIGS. 12A and 12B are a flowchart for describing a method of collecting accepted mail according to an embodiment of the present invention.

FIG. 13 is a flowchart for describing a method of collecting long-term mail according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

According to an embodiment the present invention, a user's mail is automatically accepted and collected, and the collected mail is delivered to a destination designated by the user, thereby enabling the user to more conveniently use an unmanned mail service.

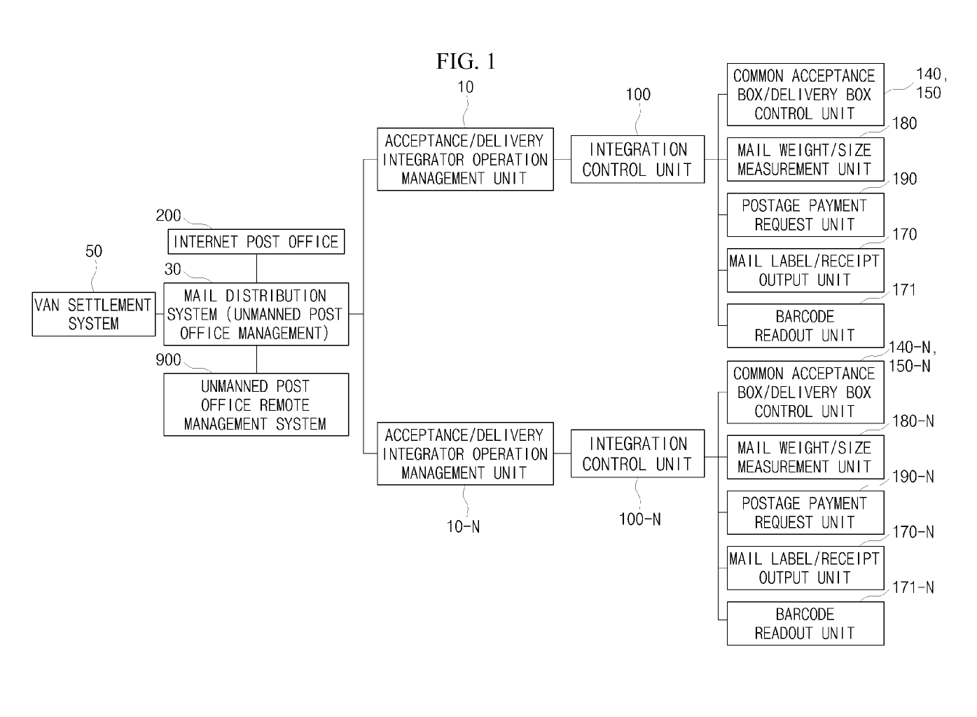

Hereinafter, a unmanned operation management apparatus for accepting mail will be described in detail with reference to FIGS. 1 to 8.

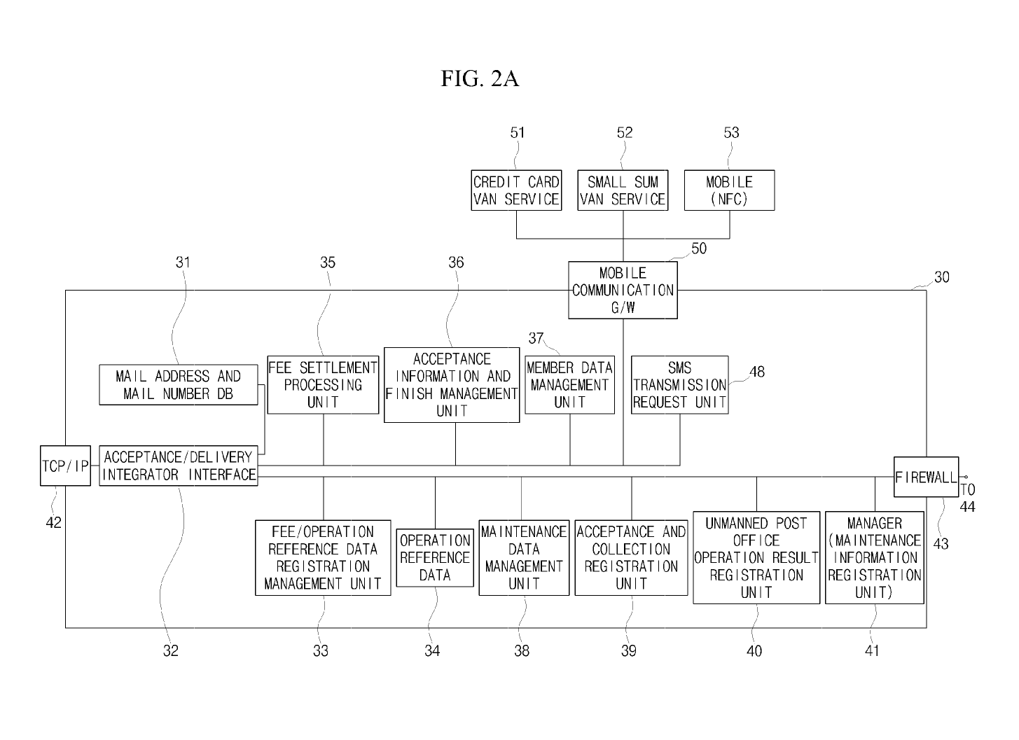

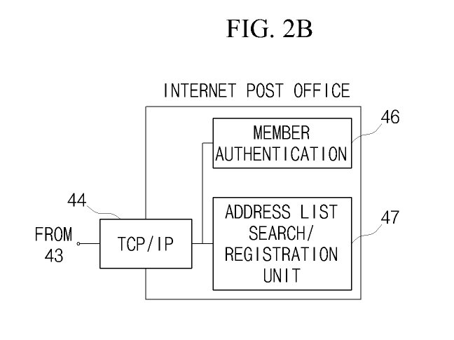

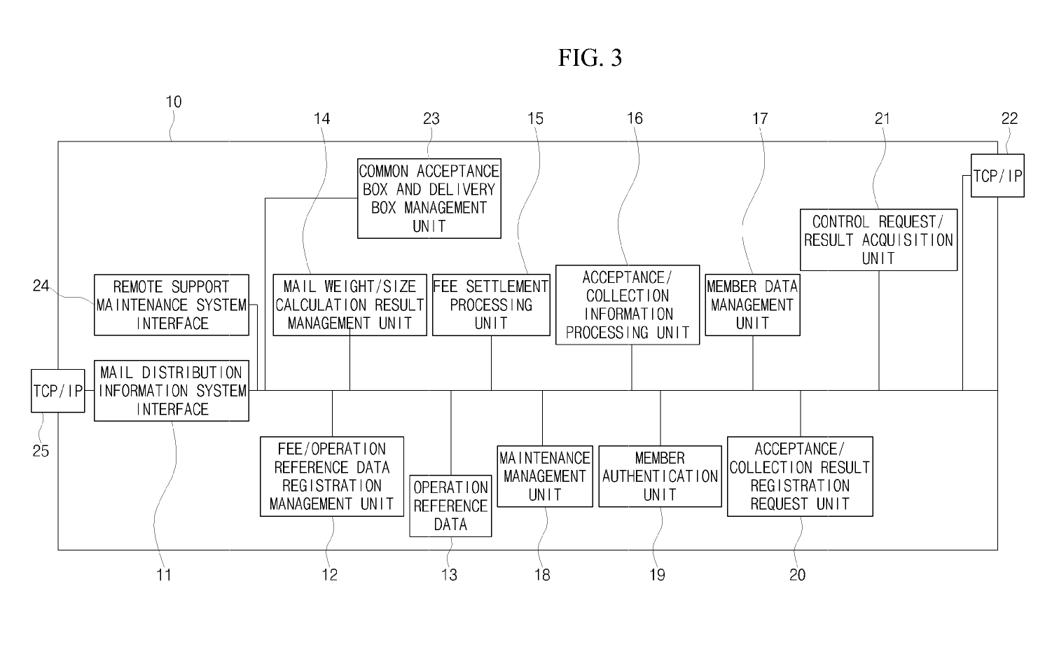

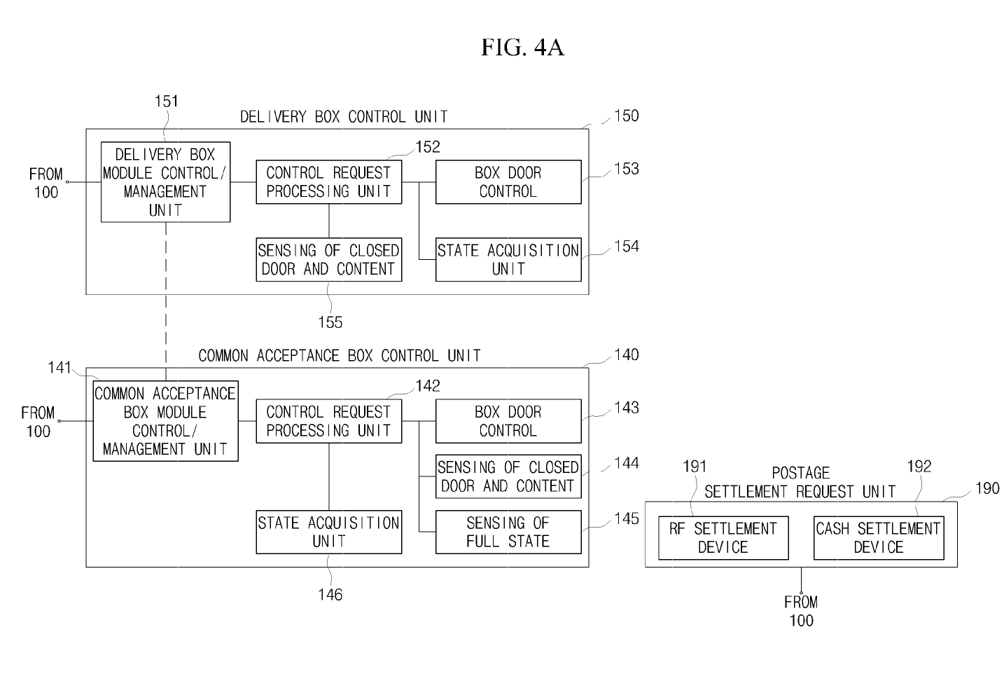

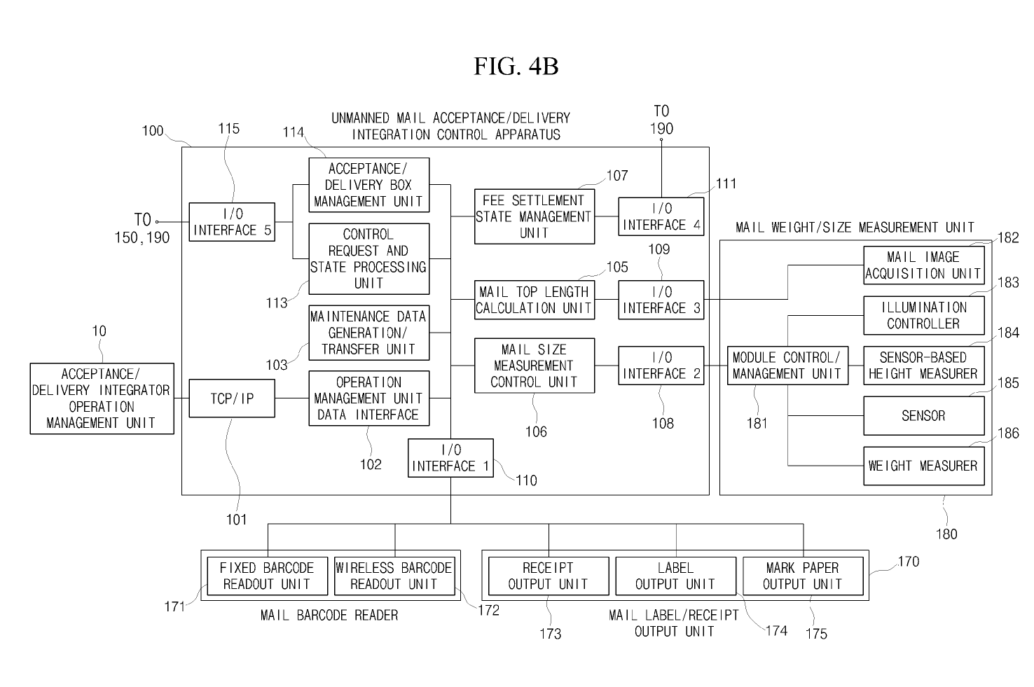

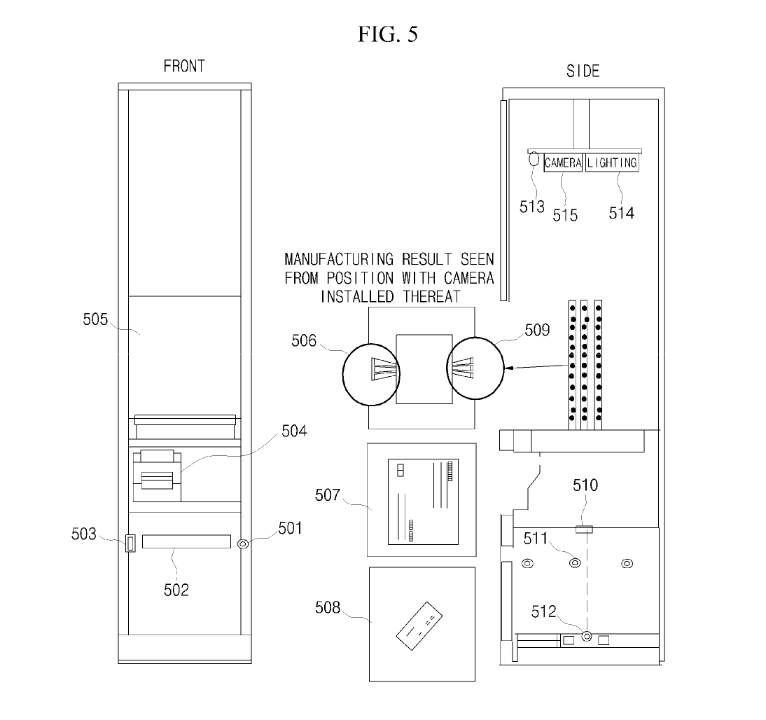

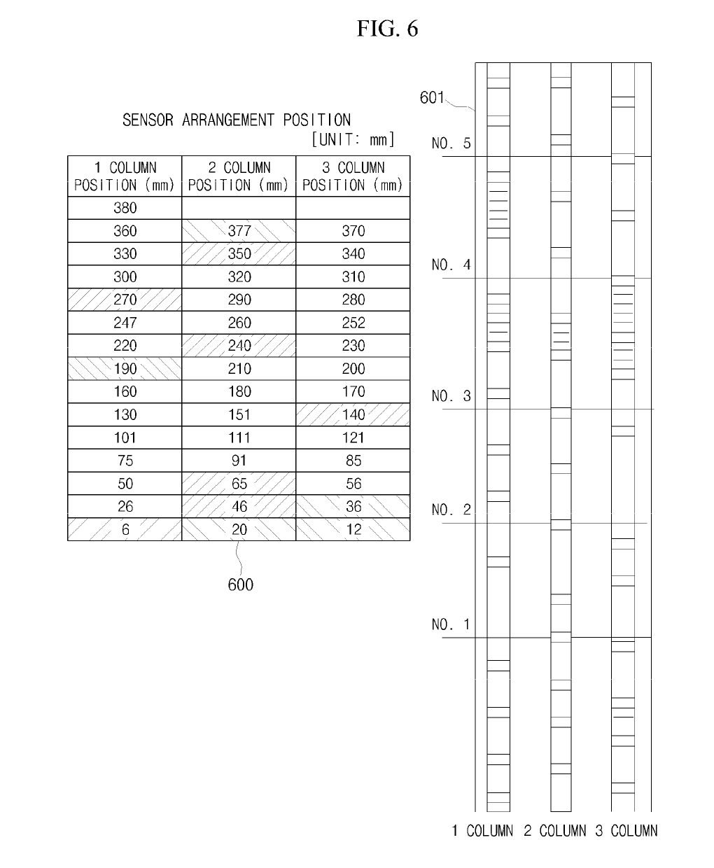

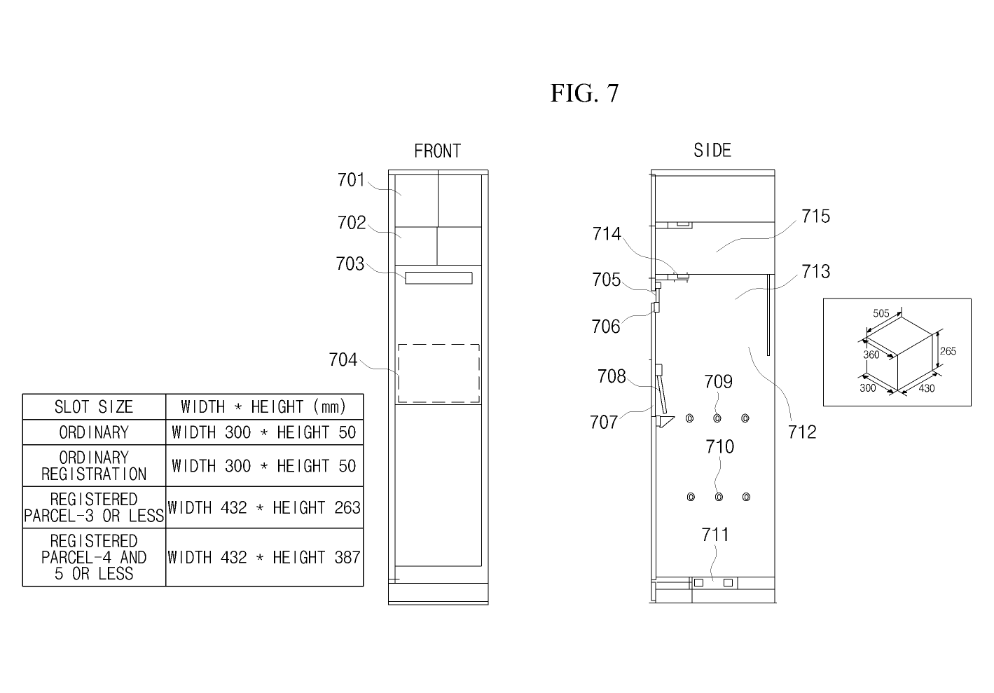

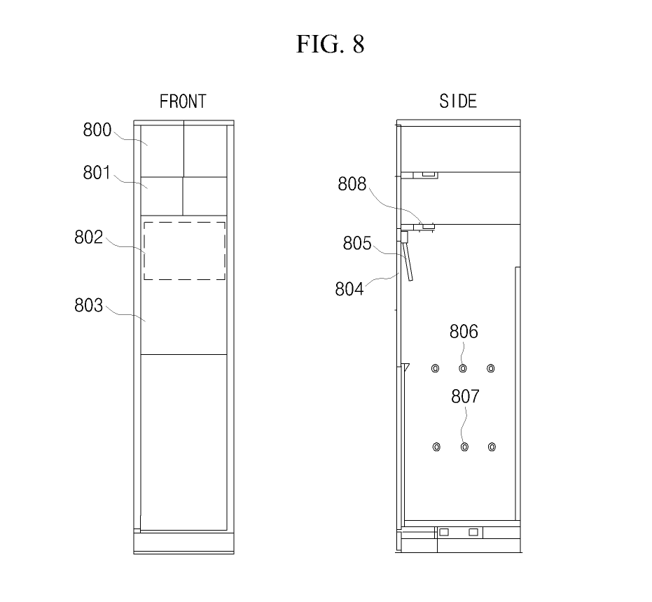

FIG. 1 is a diagram for describing an unmanned operation management apparatus for accepting mail according to an embodiment of the present invention. FIGS. 2A and 2B are diagrams for describing a mail distribution system according to an embodiment of the present invention. FIG. 3 is a diagram for describing an acceptance/delivery integrator operation management unit according to an embodiment of the present invention. FIGS. 4A and 4B are a diagram for describing an integration control unit according to an embodiment of the present invention. FIG. 5 is a diagram for describing an ordinary mail common acceptance box according to an embodiment of the present invention. FIG. 6 is a diagram for describing a configuration of a sensor according to an embodiment of the present invention. FIG. 7 is a diagram for describing a common acceptance box and a parcel delivery box which have an ordinary registration and parcel-3 size or less according to an embodiment of the present invention. FIG. 8 is a diagram for describing a common acceptance box and a parcel delivery box which have a parcel-4 size or more according to an embodiment of the present invention.

As illustrated in FIG. 1, the unmanned operation management apparatus for accepting mail according to an embodiment of the present invention includes a plurality of acceptance/delivery integrator operation management unit 10 to 10-n and a plurality of integration control units 100 to 100-n.

Each of the acceptance/delivery integrator operation management unit 10 to 10-n is not dependent on a hardware control of a specific acceptance box and a delivery box, and is configured with an operating system through sequential interface with an Internet post office 200, a mail distribution system 30 and each of the integration control units 100 to 100-n.

Each of the acceptance/delivery integrator operation management unit 10 to 10-n requests integration control for operating the mail distribution system 30 and unmanned acceptance delivery-related devices. Each of the integration control units 100 to 100-n includes a mail weight/size measurement unit 180, a mail label/receipt output unit 170, a barcode readout unit 171, and a postage payment request unit 190. Each of the integration control units 100 to 100-n performs an integration control request, provides a control result based on the integration control request, controls a common acceptance box and a delivery box, and manages states of the common acceptance box and the delivery box.

Each of a plurality of common acceptance box/delivery box control units 140 to 140n and 150 to 150n performs control based on a request of a corresponding integration control unit, and identifies a state of the common acceptance box or the delivery box.

The Internet post office 200 searches for a use status, and the mail distribution system 30 performs an acceptance/collection/delivery/receipt work in interoperation with each of the acceptance/delivery integrator operation management unit 10 to 10-n.

That is, the unmanned operation management apparatus for accepting mail according to an embodiment of the present invention may apply improved devices for providing an unmanned mail service through each of the acceptance/delivery integrator operation management unit 10 to 10-n, by using each of the integration control units 100 to 100-n. When the functions of the common acceptance box and the delivery box are improved and interface with each of the integration control units 100 to 100-n, the improved common acceptance box and delivery box may be applied.

The unmanned operation management apparatus for accepting mail according to an embodiment of the present invention accepts a user's mail through an unmanned acceptance window. In this case, the unmanned operation management apparatus measures a weight of mail by using a scale so as to accept the mail in the same procedure as a procedure of accepting the mail through a manned acceptance window, measures a size of the mail by using a sensor and an image acquisition camera to calculate a postage of the mail, and settles for the calculated postage in cash or by a radio frequency (RF) card.

Moreover, the unmanned operation management apparatus for accepting mail according to an embodiment of the present invention includes a common acceptance box into which pieces of mail by kind are inserted. In a case of a registered mail which is an additional service providing target, the unmanned operation management apparatus automatically opens a door of the common acceptance box to as to allow a user to insert the registered mail, and when the user inserts the mail into the common acceptance box, the unmanned operation management apparatus recognizes the mail being inserted into the common acceptance box by using a sensor that detects an insertion of the mail, and provides mail acceptance processing check information to the user on the basis of the recognized result.

The unmanned operation management apparatus for accepting mail according to an embodiment of the present invention accepts pieces of mail by service and by kind through the common acceptance box, but when the common acceptance box is sensed as being filled with the mail, it is impossible to additionally accept mail. Therefore, the unmanned operation management apparatus determines whether a common acceptance box adjacent to the filled common acceptance box is filled with pieces of mail, and when it is determined that the adjacent common acceptance box is not filled, the unmanned operation management apparatus accepts mail through the unfilled common acceptance box, namely, the acceptance-enabled common acceptance box. When all common acceptance boxes are filled with pieces of mail, the unmanned operation management apparatus automatically assigns a delivery box on the basis of a mail size and size measurement result information, and accepts mail through the assigned delivery box.

In comparison with a prior art, the unmanned operation management apparatus for accepting mail according to an embodiment of the present invention more effectively measures a height value of mail so as to measure a size of the mail even in a narrow space, and measures a height value of the mail, based on a value affecting an acceptance fee in accepting the mail, and when the mail is located at the center of the mail weight/size measurement unit 180 by a user, the unmanned operation management apparatus measures a height of the mail by using a plurality of sensors which are arranged in a plurality of columns, and calculates a width length value and height length value (a width and an upper area) of the mail by using the image acquisition camera. When a box is filled with pieces of mail, the unmanned operation management apparatus notifies a collection worker of data including positions, numbers, and acceptance amount of the common acceptance box and the delivery box so that the mail inserted into the common acceptance box and the delivery box are collected, and provides state information of goods consumed by the user in accepting the mail in order for the goods to be maintained and repaired.

As illustrated in FIGS. 2A and 2B, the mail distribution system 30 includes an acceptance/delivery integrator interface 32, a fee/operation reference data registration management unit 33, and a member data management unit 37.

When data about a mail address and mail number database (DB) 31 and operation reference (postage, a delivery condition, etc.) data 34 are changed, the mail distribution system 30 registers a change completion date in the fee/operation reference data registration management unit 33, and when the change completion date is registered in the fee/operation reference data registration management unit 33, the mail distribution system 30 transfers the changed data through acceptance/delivery integrator interface 32 in order for the changed data to be reflected in the acceptance/delivery integrator operation management unit 10.

The member data management unit 37 registers address list data which is to be used when mail of a member-registered user is accepted.

That is, by using the member data management unit 37, the member-registered user may register the address list data which is to be used when mail of a member-registered user is accepted in an unmanned post office.

As illustrated in FIG. 3, the acceptance/delivery integrator operation management unit 10 includes a mail distribution information system interface 11, a fee/operation reference data registration management unit 12, a mail weight/size calculation result management unit 14, an acceptance/collection information processing unit 16, a member data management unit 17, and a member authentication unit 19.

When a current date reaches an operation management date change reference, the acceptance/delivery integrator operation management unit 10 allows the fee/operation reference data registration management unit 33 to search for the presence of a change, by using the mail distribution information system interface 11 and the acceptance/delivery integrator interface 32. The acceptance/delivery integrator operation management unit 10 acquires, as the search result, data change history information about data of the mail address and mail number DB 31 and the operation reference (postage, a delivery condition, etc.) data 34, and allows the fee/operation reference data registration management unit 12 to register the acquired data change history information in operation reference data 13.

The acceptance/delivery integrator operation management unit 10 allows the mail weight/size calculation result management unit 14 to calculate a mail length necessary for calculating postage for mail acceptance. When a service is selected, the acceptance/delivery integrator operation management unit 10 allows the acceptance/collection information processing unit 16 to apply the selected service as fee calculation data, and searches for a mail number or an address name to receive sender/receiver address information. When an additional service is selected, the acceptance/delivery integrator operation management unit 10 automatically selects a deliver district on the basis of a receiver address and a mail number of an unmanned post office. In a case of a long distance (a predetermined distance or more), a transport means is selected by a user, and the acceptance/delivery integrator operation management unit 10 calculates postage on the basis of selected information and the operation reference data 13 for postage calculation.

When a user's mail is ordinary registration or a registered parcel, the acceptance/delivery integrator operation management unit 10 may allow the user to select a transport means, and calculate postage. When additional acceptance is needed, the acceptance/delivery integrator operation management unit 10 may sequentially repeat the above-described operation of measuring at least one of weight and a size and operations subsequent thereto.

When a user's mail is a general parcel, the acceptance/delivery integrator operation management unit 10 may allow the user to select a delivery district without inputting a sender/receiver address. When the user is a member, the acceptance/delivery integrator operation management unit 10 may allow the user to search for and use a registered address for simplifying an input of acceptance information in accepting mail.

For example, when a user inputs a member number and a password, the acceptance/delivery integrator operation management unit 10 accesses the member data management unit 37 through the mail distribution information system interface 11, and when the user is authenticated by the member authentication unit 19, the acceptance/delivery integrator operation management unit 10 receives member address data and receiver address list data, which are member management data, from the member data management unit 37, and temporarily stores the received member address data and receiver address list data in the member data management unit 17.

As described above, the present sequentially accepts pieces of mail and perform a package settlement. For unmanned mail acceptance/delivery, as illustrated in FIGS. 4A and 4B, the integration control unit 100 includes an operation management unit data interface 102, a fee settlement state management unit 107, and a postage settlement request unit 190.

When a settlement request is issued by the postage settlement request unit 190, the integration control unit 100 allows the fee settlement state management unit 107 to transfer a settlement approval request to a fee settlement processing unit 15 of the acceptance/delivery integrator operation management unit 10 through the operation management unit data interface 102.

The fee settlement state management unit 107 acquires and generates settlement information based on an identification (ID) corresponding to each of transportation card, credit card, debit card, and near field communication (NFC) settlement methods, and transfers the settlement information to the fee settlement processing unit 15.

When a cash balance of a cash settlement device 192 is insufficient, the integration control unit 100 allows the other balance to be settled by RF card by using an RF settlement device 191.

When a fee settlement is completed, the integration control unit 100 outputs labels (which are selected in an acceptance order) by mail kind and by service one by one, and when the output of the labels is completed, the integration control unit 100 provides a receiver name of mail, which is to be accepted, to allow mail corresponding to a door-opened common acceptance box to be submitted.

The integration control unit 100 issues a fee settlement request through the mail distribution information system interface 11 and the acceptance/delivery integrator interface 32.

For example, when the fee settlement request is received from the integration control unit 100 through the acceptance/delivery integrator interface 32, the fee settlement processing unit 35 requests approval from a corresponding settlement request VAN company through a mobile communication gateway (G/W) 50, and receives a result based on the request though the gateway 50.

A fee settlement result is output through a user screen.

The acceptance/delivery integrator operation management unit 10 performs acceptance immediately before the fee settlement request, and transmits stored acceptance data to the mail distribution system 30. When the acceptance data is received, the mail distribution system 30 stores the received acceptance data in a temporary storage by using an acceptance information and finish management unit 36.

When a reception completion of the acceptance data is checked in the mail distribution system 30, the acceptance/delivery integrator operation management unit 10 temporarily stores a quantity of mail and fee for each accepted mail for checking a finish processing result, and deletes all content including personal information.

That is, by using the acceptance/collection information processing unit 16, the acceptance/delivery integrator operation management unit 10 deletes personal information which is used in an acceptance operation, for preventing personal information from being leaked due to stored data.

The acceptance/delivery integrator operation management unit 10 submits settlement-completed mail to a common acceptance box, which is assigned by a common acceptance box and delivery box management unit 23, by using a control request/result acquisition unit 21.

When an acceptance or collection work is completed, the acceptance/delivery integrator operation management unit 10 transfers a result through the mail distribution information system interface 11 by using an acceptance/collection result registration request unit 20, and registers the result by using an acceptance and collection result registration unit 39.

When collection is completed, the acceptance/collection result registration request unit 20 transfers a finish processing request message to the acceptance information and finish management unit 36 of the mail distribution system 30, and when the a finish processing result is received, the acceptance/delivery integrator operation management unit 10 ends a collection work.

The common acceptance box/delivery box control units 140 and 150 perform a door opening control operation, a closed state determination operation, and an inserted state determination operation which are determined by the acceptance/delivery integrator operation management unit 10 and are requested by the integration control unit 100. The common acceptance box/delivery box control units 140 and 150 provides a performed result and a state (unavailable, available, full, and in use) of an acceptance/delivery box, namely, performance state data, to the integration control unit 100 so as to be managed by the integration control unit 100.

The integration control unit 100 provides an operating state of each of a common acceptance box and a delivery state to the acceptance/delivery integrator operation management unit 10, and transmits, through a short message service (SMS), maintenance content to a mobile phone of a maintenance worker registered in a manager (maintenance) information registration unit 41 by using a transmission request unit 48.

While an acceptance and collection function is being performed, in a case where when mail is located at the mail weight/size measurement unit 180 and is sensed by a sensor (i.e., a weight measurer 186), when acquisition of a height measurement value is completed by a sensor-based height measurer 184 under a control of a mail size measurement control unit 106, an illumination controller 183 turns on an illumination, and a mail image acquisition unit 182 acquires a mail image. When acquisition of the mail image is completed, the illumination controller 183 turns off the illumination.

A mail top length calculation unit 105 calculates a total length of a mail top on the basis of the mail image acquired by the mail weight/size measurement unit 180, and provides the calculated result (a mail size calculation result) to the mail weight/size calculation result management unit 14 of the acceptance/delivery integrator operation management unit 10.

In settling for postage, the integration control unit 100 provides a fee settlement means, which is provided by the acceptance/delivery integrator operation management unit 10, to a user. The fee settlement state management unit 107 provides a settlement result (settlement history data) to the fee settlement processing unit 15 of the acceptance/delivery integrator operation management unit 10, thereby allowing postage to be settled.

An acceptance/delivery box management unit 114 checks states of a common acceptance box and a delivery box by using a common acceptance box module control/management unit 141 of the common acceptance box control unit 140, a delivery box module control/management unit 151 of the delivery box control unit 150, and a plurality of state acquisition units 146 and 155. When operating states (a full state, an available state, and an unavailable state) of the common acceptance box and the delivery box are changed, the changes are stored in a temporary storage, and are transferred to the common acceptance box and delivery box management unit 23 of the acceptance/delivery integrator operation management unit 10.

Moreover, the integration control unit 100 determines whether the common acceptance box is full and there is a spare delivery box, and minimizes the number of cases where an acceptance of mail is canceled while starting acceptance.

In an acceptance operation, the common acceptance box and delivery box management unit 23 compares a mail size and service selection content, and when an automatic open control request for a selected box is issued by the control request/result acquisition unit 21, the common acceptance box and delivery box management unit 23 transfers a control request of the integration control unit 100 and a performance result of the state processing unit 113 to the acceptance/delivery integrator operation management unit 10 through the operation management unit data interface 102.

When an operation request, result management history, consumable goods balance change history, number of errors of sensor/door control, and insufficient balance of each element connected to the integration control unit 100 are determined, a maintenance data generation/transfer unit 103 provides the determined results to the acceptance/delivery integrator operation management unit 10.

Measurement of at least one of a weight and size of mail is performed the integration control unit 100 for automatically accepting and delivering mail. In accepting the mail, as illustrated in FIG. 5, an ordinary mail common box is provided along with the mail weight/size measurement unit 180. When mail is located in a weight measurement space 505 in automatically accepting the mail, the integration control unit 100 measures a weight of the mail by using a scale 500, and simultaneously determines whether there is the mail, by using an object sensor 513 installed at an upper portion of the weight measurement space 505. When the mail is sensed by a monitoring sensor, states of arranged sensor column modules 509 are inspected sequentially from a lower end, for acquiring a height value of the mail. When the mail covers a reflective plate 506, a sensor is turned on, and the height value of the mail is generated from a result in which the sensor is sensed as being turned on.

Reference numeral 507 refers to a large parcel, and reference numeral 508 refers to a mail image acquisition result of a top of small ordinary mail (standard).

In order to measure a height of mail to meet the above-described conditions, as illustrated in FIG. 6, a plurality of sensors are provided in a plurality of columns so that a measurement error, a mail standard inspection reference, and a submission reference value are determined, and are arranged so that interference between sensor modules or interference between sensors does not occur. Positions 600 and 601 of the sensors are arranged based on a design result, and a reflective plate is attached to a position parallel to a sensor. The sensors perform sensing according to the presence of reflection, standard of mail is detected, and a length of the mail is calculated.

For example, whether a size is exceeded and mail is ordinary mail is detected by determining an operating state of a height measurement sensor.

When a sensor disposed at a position of 377 mm is turned on, it is detected (present mail as acceptance limitation mail) that mail exceeds an acceptance limitation height. When a sensor disposed at a position of 6 mm is turned off, it is determined that mail is standard mail. When the sensor disposed at the position of 6 mm is turned on, it is determined that the mail is nonstandard mail. When a sensor disposed at a position of 56 mm is turned on, mail is assigned as parcel mail. When the sensor disposed at the position of 56 mm is turned off and a sensor disposed at a position of 46 mm is turned on, mail is recognized as ordinary nonstandard mail. Through such operations, it is set that mail is submitted to a parcel common acceptance box.

To provide a description on a height value calculation condition and calculation, inspection is performed in a direction from a position value “6 mm” to a position value “38 mm” with respect to a position of a height sensor. As the inspection result, a state “on->off” occurs, and then, when all sensors to be subsequently inspected are turned off, a value of a turn-on sensor changed to a state “on->off” is calculated as a height value. Inspection is performed in the direction from the position value “6 mm” to the position value “38 mm” with respect to the position of the height sensor. As the inspection result, the state “on->off” occurs, and then, when there is a sensor which is turned on among sensors disposed at a next position, a height value is calculated by a proposed method. A mail height value is generated by applying the following three methods:

Height value calculation example 1) on1->off1->off2,height value=on1 value

Height value calculation example 2) on1->off1->on2->off2->off3,height value=[off1+on2]/2

Height value calculation example 3) on1->off1->on2->off2->on3->off3->off4,height value=[on2+off1+on3+off2]/4

Embodiment) a 320 mm position sensor (on1)->a 330 mm position sensor (off1)->a 340 mm position sensor (on2)->a 350 mm position sensor (off2)->a 360 mm position sensor (on3)->a 370 mm position sensor (off3)->a 377 mm position sensor (off4), height value=(330+340+350+360)/4=345 mm

An ordinary common acceptance box includes a slot 502, and three sensors 511 for sensing a full state of mail are provided in the ordinary common acceptance box. When one of the three sensors 511 is detected as a turn-on state, the ordinary common acceptance box is determined as full. When a bottom of the ordinary common acceptance box includes a sensor 512 and a reflective plate 510, for determining there is a mail box when the mail box is inserted into the ordinary common acceptance box or determining whether there is mail inserted into the ordinary common acceptance box when there is no mail box.

Whether mail is inserted into the common acceptance box may be determined based on a state in which an on-off change is caused by a first sensor of the three sensors. To provide a mark paper output result of parcel mail, a mark paper printer is fixed to a position 504, there enabling a customer to easily recognize an output label.

A common acceptance box and a parcel delivery box which have an ordinary registration and parcel-3 size or less are as illustrated in FIG. 7.

A slot 703 is a slot of an ordinary registration common acceptance box, and a lock device 706 may be automatically opened or closed by the common acceptance box/delivery box control unit 140 of the integration control unit 100.

A common acceptance box having the parcel-3 size or less includes a sensor. In the sensor, a door 707 is automatically opened for inserting mail. When parcel mail is submitted to a slot 704, the sensor determines a state in which the common acceptance box is filled with pieces of mail by 50% or 100%, in consideration of a mail insertion state and a size of an acceptance mail insertion space.

A method of determining a mail insertion state and full state of the ordinary registration mail common acceptance box is the same as that of an ordinary common acceptance box.

A common acceptance box and a parcel delivery box which have a parcel-4 size or more are as illustrated in FIG. 8.

The common acceptance box having a parcel-4 size or more includes a sensor. In the sensor, a door 804 is automatically opened for inserting mail. When parcel mail is submitted to a slot 802, the sensor determines a state in which the common acceptance box is filled with pieces of mail by 50% or 100%, in consideration of a mail insertion state and a size of an acceptance mail insertion space.

The common acceptance box and delivery box management unit 23 assigns a parcel mail common acceptance box, and when all parcel common acceptance boxes are full, the common acceptance box and delivery box management unit 23 assigns a spare delivery box for receiving submitted parcel mail, based on the number of spare delivery boxes by size.

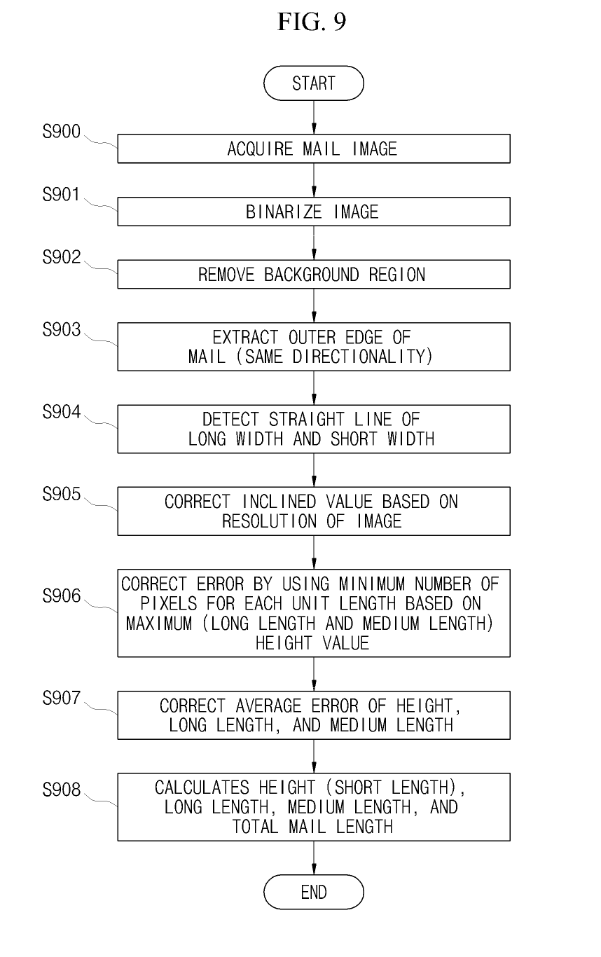

Hereinabove, the unmanned operation management apparatus for accepting mail according to an embodiment of the present invention has been described with reference to FIGS. 1 to 8. Hereinafter, a method of controlling the unmanned operation management apparatus for accepting mail according to an embodiment of the present invention has been described in detail with reference to FIGS. 9 to 13.

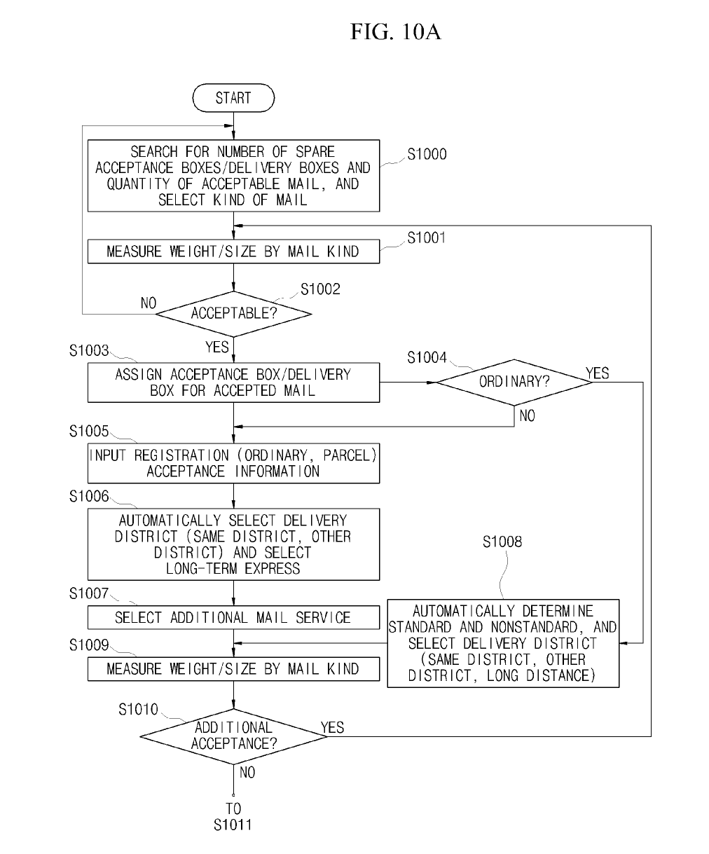

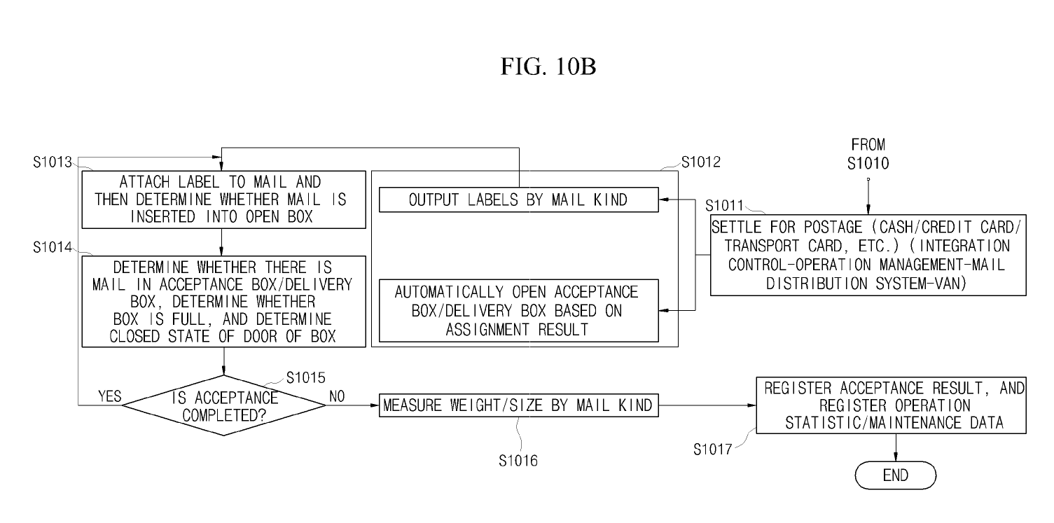

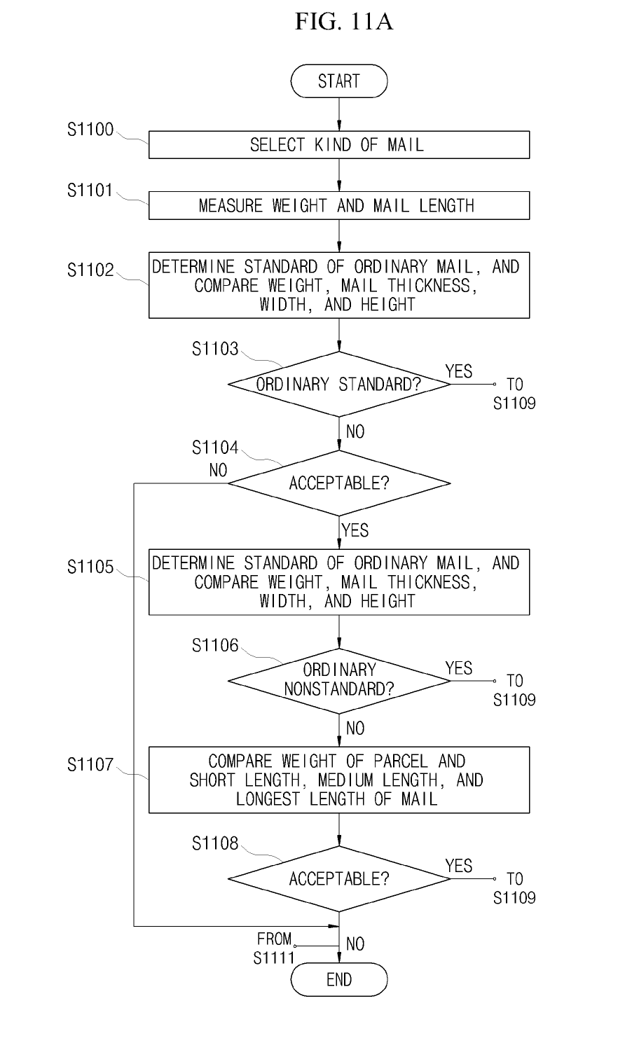

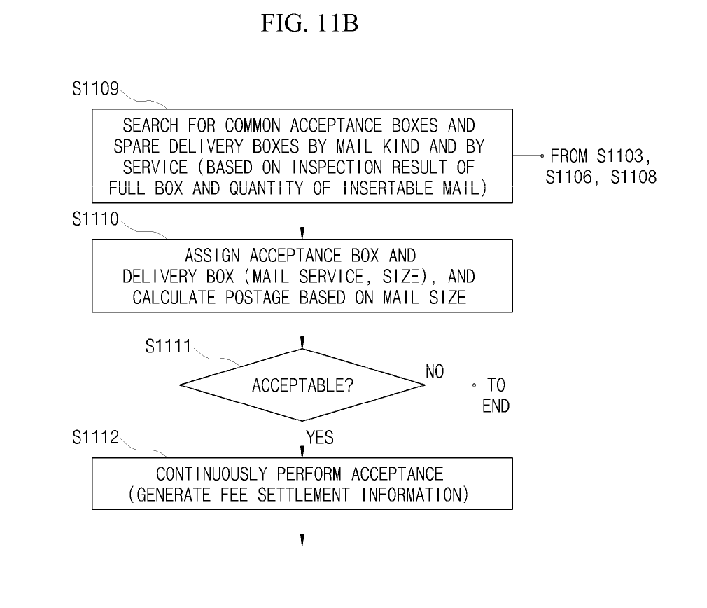

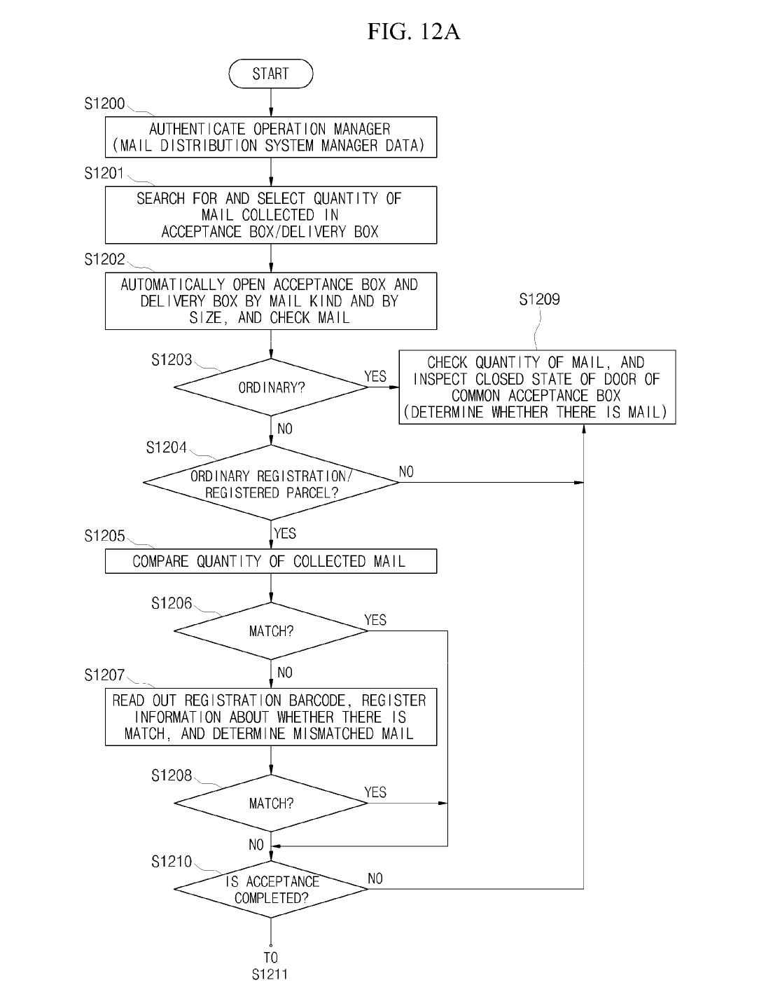

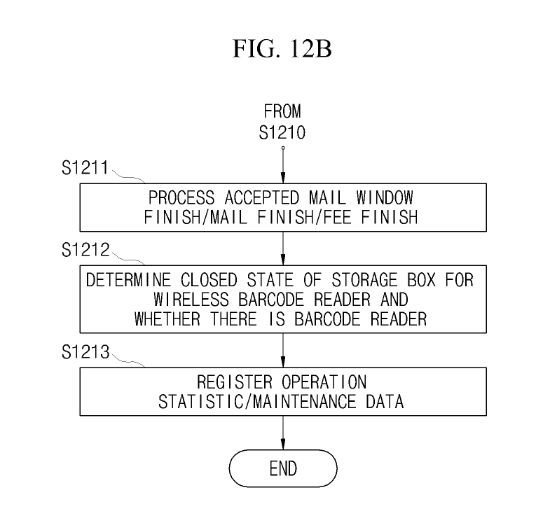

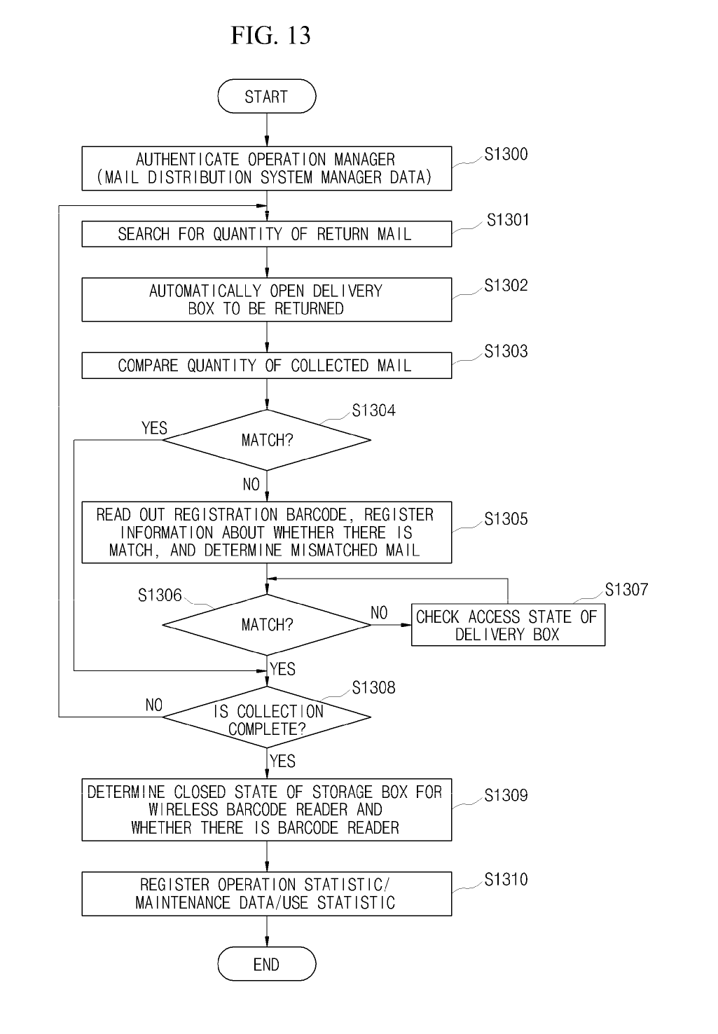

FIG. 9 is a flowchart for describing a method of calculating a length of a top of mail from an acquired mail image according to an embodiment of the present invention. FIGS. 10A and 10B are a flowchart for describing a mail accepting method according to an embodiment of the present invention. FIGS. 11A and 11B are a flowchart for describing a method of calculating a mail acceptance fee and providing an acceptance condition check result, according to an embodiment of the present invention. FIGS. 12 A and 12B are a flowchart for describing a method of collecting accepted mail according to an embodiment of the present invention. FIG. 13 is a flowchart for describing a method of collecting long-term mail according to an embodiment of the present invention.

First, as illustrated in FIG. 9, a method of calculating a length of a mail top from an acquired mail image acquires a calculated mail height value and a mail image in step S900, and transforms the acquired mail image into binary data in step S901.

Before acquiring an image including mail, the method removes a background region on the basis of a difference value between a background image and an image (the image including the mail) in which the mail is provided in step S902, extracts an edge portion of an outer portion of the mail in step S903, calculates the largest value of width values of a short side and a long side of a straight line with the consideration of directionality (the same directionality) to detect the longest length value and a medium length value in step S904, and calculates and corrects an inclined angle value which occurs in inserting the mail in step S905.

The method corrects an error, caused by a height value and a resolution value of the acquired image, by using the minimum number of pixels for each unit length based on the height value in step S906. The method corrects an average error of a height, a long length, and a medium length in step S907. Through the correction, the method calculates a height (a short length), a long length, a medium length, and a total mail length in step S908.

In the present embodiment, steps S906 and S907 are provided as described above, but are not limited thereto. The method may register a height value registered before acquiring the mail image, previously register a difference value between an actual measurement value and a value acquired from images by mail size, and calculate an average error value between lengths of a long side and a short side. The method may reflect the calculated error value in steps S906 and S907 to correct a length of each side of the mail based on the error value to calculate a length of the mail.

As illustrated in FIGS. 10A and 10B, when a mail acceptance request is issued by a user, a mail accepting method searches for the number of spare acceptance boxes/delivery boxes which are operated so far in step S1000, namely, searches for the number of spare acceptance boxes/delivery boxes and a quantity of acceptable mail. The kind of mail is selected, and when an acceptable quantity value is checked, the method measures a weight and size of the mail based on the selected kind of mail in step S1001.

The method checks whether it is possible to accept the mail in step S1002, and when it is checked that it is possible to accept the mail, the method assigns an acceptance box/delivery box for the accepted mail in step S1003.

For example, the method checks whether a delivery/acceptance box is full, and when it is checked that the delivery/acceptance box is full, the method informs a customer that it is unable to accept mail. When it is checked that the delivery/acceptance box is not full, the method checks whether mail is acceptable mail, based on a weight and size of the mail. That is, the method compares a weight value and a size value to determine whether it is possible to accept the mail, and when the mail is the acceptable mail, the methods assigns an acceptance box or a delivery box.

The method checks whether the mail is ordinary mail in step S1004, and when the mail is not the ordinary mail, the method receives registration (ordinary or parcel) acceptance information in step S1005.

For example, the checks whether the mail is the ordinary mail, and when the mail is not the ordinary mail as the check result, the method receives sender/receiver information.

The method automatically selects a delivery service (the same district or other district), selects long-distance express in step S1006, and selects an additional mail service in step S1007.

For example, the method automatically selects a delivery district on the basis of input acceptance information, and when the delivery district is a long-distance district, the method allows a long-distance transport means to be selected in step S1006, and selects an additional service S1007.

When it is checked in step S1004 that the mail is the ordinary mail, the method automatically determines whether the mail is standard mail or nonstandard mail, and selects a delivery district (the same district, other district, or a long distance) in step S1008. The method calculates postage on the basis of the selected information to provide the calculation result in step S1009.

The method checks whether it is possible to additionally accept mail in step S1010, namely, the method checks whether all acceptance/delivery boxes are full. When it is checked that the all acceptance/delivery boxes are not full, the method determines that it is possible to additionally accept mail, and sequentially repeats step S1001 and operations subsequent thereto. However, when it is checked that the all acceptance/delivery boxes are full, the method determines that it is impossible to additionally accept mail, and requests a postage settlement in step S1011.

That is, when additional acceptance of all mail is completed, the method performs a fee settlement, and when the fee settlement for mail acceptance is completed, the method submits mail based a mail service and a mail size.

For example, when the submitted mail is ordinary mail and is checked as mail that can be inserted in an ordinary common acceptance box by the acceptance/delivery integrator operation management unit 10, the method outputs a label for accepted mail by customer by using the integration control unit 100 in step S1012. When the output label is attached to ordinary mail and the label-attached ordinary mail is inserted into a designated common acceptance box, the method determines an insertion state of the ordinary mail in step S1013, and when it is determined that the mail is inserted, the method determines whether there is mail in an acceptance box/delivery box, whether the acceptance box/delivery box is full, and whether a door of the acceptance box/delivery box is closed in step S1014. The method determines whether acceptance of mail is completed, based on the determination result, and when it is determined that the acceptance of the mail is completed, the method outputs a postage receipt in step S1016.

Moreover, when the submitted mail is ordinary registration and is checked as the mail that can be inserted in an ordinary registration acceptance box by the acceptance/delivery integrator operation management unit 10, the method outputs a registration barcode label in an acceptance order by customer by using the integration control unit 100, and automatically opens a slot of the ordinary registration acceptance box in step S1012. The method provides a receiver name through a user interface so as to determine whether mail is mail which is to be submitted, and determines an insertion state of ordinary registration mail in step S1013. When insertion of mail is completed and it is determined that a door of the slot is closed in step S1014, the method determines that acceptance of mail is completed in step S1015, and outputs the postage receipt in step S1016.

When the submitted mail is an ordinary parcel, the method outputs a mark label for accepted mail by customer by using the integration control unit 100, and searches for size measurement result data of the ordinary parcel to automatically open a door of a corresponding parcel common acceptance box in step S1012. When parcel mail is inserted through a slot, the method determines an insertion state of the parcel mail in step S1013. When it is determined that the parcel mail is inserted and it is determined that a door of the slot is closed in step S1014, the method determines that acceptance of mail is completed in step S1015, and outputs the postage receipt in step S1016.

When the submitted mail is a registered parcel, the method outputs a mark paper label in an acceptance order for accepted mail by customer by using the integration control unit 100, and searches for size measurement result data of the parcel to automatically open a door of a corresponding parcel common acceptance box in step S1012. The method provides a receiver name through the user interface so as to determine whether mail is mail which is to be submitted, and when parcel mail is inserted through the slot, the method determines an insertion state of the parcel mail in step S1013. When there is mail which is to be additionally accepted, the method outputs a next mark paper label in step S1012. When it is determined that insertion of all mail is completed, the method determines whether a door of the common acceptance box is closed. When the door is closed, the method determines that acceptance is completed in step S1015, and outputs the postage receipt in step S1016.

When a common acceptance box is full and thus mail is selected as being inserted into a delivery box, the method automatically opens a door of the delivery box which is assigned for acceptance with respect to a mail size value by using the integration control unit 100 in step S1012. When mail is inserted into the delivery box, the method determines an insertion state of mail by using a sensor disposed at a bottom of the delivery box in step S1013, and when it is sensed that the door of the delivery is closed in step S1014, the method performs an operation of enabling next mail to be accepted.

Moreover, the method reads out a registration barcode of mail by using a fixed barcode reader, and when the readout result is normal, the method allows a box corresponding to a mail size to be automatically opened in step S1012.

The method registers acceptance result registration operation statistic/maintenance data in step S1017.

For example, when acceptance is completed by a customer, the acceptance/delivery integrator operation management unit 10 registers an operation history in the mail distribution system 30. Also, the acceptance/delivery integrator operation management unit 10 registers maintenance data acquired from the integration control unit 100, and transmits information (a maintenance data history) to a terminal (a mobile phone) of a maintenance worker so as to perform a maintenance work.

As illustrated in FIGS. 11A and 11B, a method of calculating a mail acceptance fee and providing an acceptance condition check result based on a weight measurement result and a length value of each side of mail performs an operation of inspecting standard of ordinary mail depending on a measurement result of selected mail by kind.

The kind of mail is selected in step S1100, and the method measures a weight and length of the selected mail in step S1101. The method compares a weight, thickness, width, and height of mail on the basis of the measurement result to determine whether the mail is ordinary mail standard in step S1102.

For example, the method compares a length value (maximum and minimum) of the mail on the basis of the length measurement value result acquired from an image of the mail to determine whether the length value of the mail is within a standard range, and determines whether the mail is standard mail, by using a reflectivity value of a mail face.

The method determines whether the mail is ordinary standard in step S1103.

For example, when a measured weight (a weight acquisition value) of mail is less than 51 g and a measured height value is less than 6 mm, the method determines the mail as ordinary standard, and when the measurement value is not within a standard range, the method determines the mail as ordinary nonstandard.

When mail is not the ordinary standard, namely, when the mail is the ordinary nonstandard, the method checks whether the mail is acceptable mail in step S1104. When the mail is the acceptable mail, the method compares a weight, thickness, width, and height of the mail on the basis of the measurement result to determine whether the mail is the ordinary mail standard in step S1105.

A nonstandard mail determination reference corresponds to a case in which a weight measurement result is less than 2 g or is equal to or greater than 51 g. When the weight measurement result is equal to or less than 6,000 g, the method determines the mail as nonstandard without performing standard inspection. When weight exceeds 6,005 g, the method allows the mail to be accepted as parcel mail.

Moreover, when a total length (width+length+height) of mail is equal to or less than 36 cm and a measured height value is equal to or greater than 6 mm, the method determines the mail as nonstandard.

The method determines whether the mail is the ordinary nonstandard, based on the determination result in step S1106.

When it is determined that the mail is the ordinary standard, namely, when the mail is the ordinary standard or a parcel, the method compares a weight of the parcel and lengths of a short side, medium side, and longest side of the mail in step S1107, and determines whether the mail is acceptable, based on the comparison result in step S1108.

For example, the method determines whether mail is unacceptable mail because a size of a common slot for ordinary registration mail is limited, and when it is determined that a longest length of the mail is less than 13.5 cm and a short length is less than 8.5 cm, the method informs a customer that the mail is the unacceptable mail, through the user interface, and disallows the mail to be accepted.

When a total length (width+length+height) of mail is less than 91 cm and a height value is less than 56 mm, the method recognizes the mail as acceptable mail to assign an ordinary/registration common acceptance box. When it is determined that the height value is equal to or greater than 56 mm, the method recognizes the mail as the acceptable mail to assign a parcel (No. 1, 2, or 3) common acceptance box, thereby allowing the mail to be accepted.

The method inspects whether a common acceptance box and a spare delivery box are full. The method searches for common acceptance boxes and spare delivery boxes by mail kind/service based on the inspection result in step S1109. The method assigns an acceptance box and a delivery box depending on a mail service and a mail size, and calculates postage based on the mail size in step S1110.

Subsequently, the method checks whether next mail is acceptable in step S1111, and when it is checked that the next mail is acceptable, the method continuously performs a mail accepting operation including a fee settlement information generating operation in step S1112.

A handling-limited item is selected according to a parcel mail acceptance reference and a postage calculation reference, and when a weight of parcel mail is equal to or greater than a weight excess inspection reference “30,005 g”, a length of one of a width, a length, and a height is equal to or greater than 550 mm, and a total length of the parcel mail is equal to or greater than 137 cm (based on a size of an acceptance slot), the method informs a user that acceptance cannot be performed by parcel.

When the longest length of parcel mail is equal to or greater than 17 cm, a medium length of is equal to or greater than 12 cm, and the shortest length is equal to or greater than 3.5 cm, the method accepts mail as a parcel (ordinary standard), and when the above-described length values are not satisfied, the method informs the customer that acceptance is performed by ordinary express, through the user interface, and allows an ordinary postage system to be reflected.

Moreover, in consideration of a size of a common acceptance box, the method compares a mail size range (which is acceptable through parcel-4 and 5 common acceptance boxes) with a total length and a long length, medium length, and height value of respective sides in step S1107, and determines whether mail is acceptable, based on the comparison result in step S1108.

For example, in a case where a total length of mail satisfies a condition which is longer than 100 cm and is less than 137 cm, the method accepts the mail as a parcel when satisfying the following conditions: a medium length (about 10 mm which is obtained by subtracting a spare value from a slot width value) of the parcel is less than 422 mm; the shortest length (a height, about 10 mm which is obtained by subtracting the spare value from a slot height value) is equal to or less than 377 mm; and the longest length is equal to or less than 551 mm.

The method compares a total mail length size range (which is acceptable through parcel-1, 2 and 3 common acceptance boxes) with the longest length, a medium length, and a height (thickness) value in step S1105, and determines whether mail is that can be inserted, based on the comparison result in step S1108.

For example, mail can be inserted under conditions in which a total length of the mail is equal to or greater than 34 cm and is less than 101 cm, a medium length (about 10 mm which is obtained by subtracting the spare value from the slot width value) is equal or less than 421 mm, the shortest length is less than about 10 mm which is obtained by subtracting the spare value from 252 mm, and the longest length is less than 551 mm.

A common acceptance box is assigned under the above-described conditions. That is, the method inspects whether a common acceptance box and a spare delivery box are full, and searches for common acceptance boxes and spare delivery boxes by mail kind/service based on the inspection result in step S1109. The method assigns an acceptance box and a delivery box depending on a mail service and a mail size, and calculates postage based on the mail size in step S1110, and uses the common acceptance box in common to accept the mail, based on a full mail sensor of a parcel mail common acceptance box.

For example, when the parcel-1, 2 and 3 common acceptance boxes are full and the parcel-4 and 5 common boxes are not full (based on a full mail of 100%), parcel-1, 2 and 3 size mail is assigned to the parcel-4 and 5 common boxes in step S1110.

Under a condition in which the parcel-4 and 5 common boxes are full and the parcel-1, 2 and 3 common acceptance boxes are not full (based on a full mail of 100%), when a medium length of parcel mail is less than 421 mm and the shortest length is less than 252 mm, a common acceptance box is assigned so that the parcel mail is processed through the parcel-1, 2 and 3 common acceptance boxes up to the maximum total mail length of 122 cm, in step S1110.

When the parcel-1, 2 and 3 common acceptance boxes are sensed as being filled by 50%, the method temporarily stores a quantity of acceptable mail as follows, and uses the stored quantity as a common acceptance box assigning condition in an acceptance procedure, in step S1110.

That is, a quantity of acceptable mail (based on Nos. 1, 2 and 3): 5, 3, and 2 pieces of mail (a quantity of mail may be registered by determining a reference quantity value depending on a size of a common acceptance box)

When the parcel-4 and 5 common acceptance boxes are determined as being filled by 50%, the method temporarily stores a quantity of acceptable mail as follows, and uses the stored quantity as the common acceptance box assigning condition in an acceptance procedure.

That is, a quantity of acceptable mail (based on Nos. 4 and 5): 1 piece of mail (a quantity of mail may be registered by determining a reference quantity value depending on a size of a common acceptance box)

When the parcel-1, 2 and 3 common acceptance boxes are impossible to accept mail because being full, and the parcel-4 and 5 common acceptance boxes are determined as being filled by 50%, the method temporarily stores a quantity of acceptable mail of the parcel-1, 2 and 3 common acceptance boxes, and uses the stored quantity as the common acceptance box assigning condition in an acceptance procedure, in step S1110.

That is, a quantity of acceptable mail (based on Nos. 1, 2 and 3): 5, 2, and 1 pieces of mail (a quantity of mail may be registered by determining a reference quantity value depending on a size of a common acceptance box)

When common acceptance boxes by mail kind are full, the method registers a full mail state history as operation result data in the mail distribution system 30 in order for a collection worker to collect mail, and simultaneously selects a spare delivery box to allow a customer's accepted mail to be submitted.

As described above, when mail is accepted through an unmanned post office, an operator checks a quantity of mail and a full mail level value which are registered in a common acceptance box and a delivery box by using the mail distribution system 30. When the common acceptance box and the delivery box are a full mail state, the operator provides collection work request information (a full mail level of a common acceptance box, a quantity of accepted mail by mail kind, a quantity of accepted mail by mail service, and an ID of an unmanned post office acceptor) to a worker terminal so as to perform a collection work in step S1017.

Moreover, as illustrated in FIGS. 12A and 12B, a method of collecting accepted mail performs the following operations. When a collection worker inputs login information, the acceptance/delivery integrator operation management unit 10 compares the input login information and manager account management data by using the mail distribution system 30 to perform authentication in step S1200. When login is completed through the authentication, the acceptance/delivery integrator operation management unit 10 provides a quantity of mail by common acceptance box or delivery box in correspondence with accepted mail in step S1201. When a specific part or entire part of a common acceptance box and delivery box for collection is selected, the acceptance/delivery integrator operation management unit 10 automatically opens a door of the common acceptance box or the delivery box according to the selection, and allows the collection worker to check the door-opened common acceptance box or delivery box in step S1202.

That is, the collection worker may check whether mail is ordinary mail when collecting the mail from the door-opened common acceptance box or delivery box.

The collection worker determines whether the checked mail is the ordinary mail in step S1203. When it is determined that the checked mail is not the ordinary mail, the collection worker checks whether the mail is ordinary registration/registered parcel in step S1204. When it is checked that the mail is the ordinary registration/registered parcel, the collection worker collects the mail, and compares a quantity of mail in step S1206. When there is a match in a quantity of collected mail as the comparison result, the collection worker reads out a barcode of the mail by using a wireless barcode reader or a fixed barcode reader.

For example, in consideration of a movement distance of the acceptance/delivery integrator operation management unit 10 and the common acceptance box or the delivery box, a door of a storage box for the wireless barcode reader may be implemented to be automatically opened, and the collection worker may read out a barcode of mail by using the wireless barcode reader provided in the storage box for the wireless barcode reader, and collect mail.

The method reads out the barcode of the mail to determine whether there is a match in a quantity of collected mail, and determines mismatched mail in step S1207.

The method determines whether there is a match in the quantity of the collected mail by determining the mismatched mail in step S1208.

When it is determined in step S1203 that the mail is not the ordinary mail or it is checked in step S1204 that the mail is not the ordinary registration/registered parcel, the method checks a quantity of mail, and inspects a closed state of a door of the common acceptance box (checks whether mail remains in a box) in step S1209. When it is determined in step S1206 or S1208 that there is a match in the quantity of the collected mail, the method determines whether collection of mail from the common acceptance box or the delivery box is completed in step S1210.

When mail does not remain in the common acceptance box or the delivery box or the door of the delivery box is closed, the method determines that the collection of the mail from the common acceptance box or the delivery box is completed, and processes an accepted mail window finish/mail finish/fee finish in step S1211. When the storage box for the wireless barcode reader is opened, the method determines a closed state of the door and whether the barcode reader is provided in the storage box for the wireless barcode reader in step S1212. When the barcode reader is provided in the storage box for the wireless barcode reader and the door of the storage box for the wireless barcode reader is closed, the method registers operation statistic/maintenance data in step S1213.

For example, a collection result may be registered according to whether a quantity of collected mail matches a quantity of accepted mail which is inserted into the common acceptance box or the delivery box.

However, when the storage box for the wireless barcode reader is closed, step S1213 may be immediately performed without performing step S1212.

In reading out a barcode of mail, the method compares the barcode with a registration number stored in the acceptance/delivery integrator operation management unit 10 to determine whether there is a match between them. The method determines whether there is mail which is not read out, based on a readout result. The method may provide, through the user interface, information for classification by delivery district and by service based on the readout result. By reading out the barcode, the method generates and provides handover information of mail to be collected in a operation of collecting the mail. When there is a mismatch between accepted mail and collected mail, the method performs a 1:1 comparison, thereby preventing lost or accepted mail from not being collected.

In a case of registered mail, the method may collect mail which is accepted in an open common acceptance box or delivery box, and when it is determined that a door of the box is closed, the method may provide a position of the box so as to check whether mail remains in the box.

Since an ordinary common acceptance box is usable under the same condition as that of a post office, the method provides whether there is inserted mail, information about a quantity of mail which is determined in insertion, and information about a quantity of accepted mail, thereby providing an ordinary mail quantity value so as to check a quantity of collected mail.

When a collection completion processing operation is selected, the method notifies the mail distribution system 30 of information which allows a window finish (partial, entire, fee calculation) of accepted mail to be performed in step S1207. The method provides the mail distribution system 30 with data about a quantity of mail and fee for verifying a finish processing result, and when a finish processing operation is completed, the method accepts mail (which is accepted after a collection work is completed) as after-finish accepted mail, and allows a quantity of mail, accepted after the collection work, to be separately managed.

When operation management date data is changed to a next day, the method normally accepts mail which is accepted after finish, thereby allowing daily accepted mail quantity information to be easily managed.

In the operation, the method notifies an operation manager of operation error data for maintenance as maintenance data such as an insufficient balance state and states of consumable goods which are connected to an acceptance device and used. The method registers the maintenance data in the mail distribution system 30 to previously perceive content necessary for maintenance, and allows maintenance to be easily made through visit. The method registers a maintenance result, and when a maintenance delay factor occurs, the method uses the maintenance delay factor as data for an analysis of a cause so as to manage the maintenance data.

Moreover, a method of collecting long-term mail is as illustrated in FIG. 13.

The method authenticates an operation manager on the basis of manager data of the mail distribution system 30 in step S1300. The method searches for a list of long-term mail in a collecting operation to provide information which allows a return processing target to be collected, and selects a delivery box which is to be returned in step S1301 to automatically open a door of the delivery box in step S1302, thereby allowing the delivery box to be returned.

The method compares collected return mail in step S1303, and when there is no match in a quantity of the collected return mail in step S1304, a collection worker reads out a barcode of mail by using the wireless barcode reader or the fixed barcode reader.

For example, in consideration of a movement distance of the acceptance/delivery integrator operation management unit 10 and a delivery box which is to be returned, the door of the storage box for the wireless barcode reader may be implemented to be automatically opened, and the collection worker may read out a barcode of return mail by using the wireless barcode reader provided in the storage box for the wireless barcode reader, and collect the return mail.

The method reads out the barcode of the return mail to determine whether there is a match in the quantity of the collected return mail, and determines mismatched return mail in step S1305.

The method determines whether there is a match in the quantity of the collected return mail by determining the mismatched return mail in step S1306.

When it is determined that there is a mismatch in the quantity of the collected return mail, the method registers the return mail as acceptance-completed mail at a date at which a delivery box access state is checked and the delivery box is accessed.

However, when there is a match in the quantity of the return mail or it is determined in step S1303 that there is a match in the quantity of the collected return mail, the method checks whether the collection of the return mail is completed in step S1308. When it is checked that the collection of the return mail is completed, the method checks whether the storage box for the wireless barcode reader is opened. When the storage box for the wireless barcode reader is opened, the method determines a closed state of the storage box for the wireless barcode reader and whether there is the wireless barcode reader in step S1309. When there is the wireless barcode reader in the storage box and the door of the storage box is closed, the method registers operation statistic/maintenance data/use result in step S1310.

However, when the door of the storage box for the wireless barcode reader is closed, step S1310 may be immediately performed without performing step S1309.

The method registers return mail processing data in the mail distribution system 30, and acquires return information by using a personal digital assist (PDA) of the existing deliverer. The method may provide mail quantity information and a position of a box including mail for which return is needed due to long-term storage, and thus may not separately transmit and resister a return processing history.

According to the embodiments of the present invention, a mail size that is a reference for calculating postage can be more efficiently and accurately measured, and by configuring and operating the mail assortment common acceptance box, a mail collecting work can be easily performed.

Moreover, when the common acceptance box is filled with pieces of mail, mail is accepted by using the spare delivery box, thereby preventing a problem caused by a lack of an acceptance box.

Moreover, by enabling an operator to check maintenance-related information, a maintenance work can be performed in time.

In particular, when information used in accepting mail is changed, a manual change work may not be performed by applying the changed information in time, and thus, a stable environment for mail acceptance can be provided, thereby reducing the operating cost.

Moreover, an unmanned post office is built without using an unmanned mail acceptance device by mail size type, thereby minimizing the cost for building the unmanned post office.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An unmanned operation management apparatus for accepting mail comprising:
an integration control unit configured to acquire size information of mail by using a reflective plate and a plurality of sensors which are respectively installed at predetermined positions in parallel correspondence with the reflective plate; and
an acceptance/delivery integrator operation management unit configured to calculate postage, based on the acquired size information of the mail and main acceptance information input by a user,
wherein the integration control unit settles for the mail according to the calculated postage, assigns a mail common acceptance box according to whether boxes are full, and allow the mail to be inserted into the assigned mail common acceptance box.

2. The unmanned operation management apparatus of claim 1, wherein,
the integration control unit further comprises a plurality of sensors which are installed in the mail common acceptance box, and
when there are a predetermined number or more of sensing values corresponding to an on state among a plurality of sensing values respectively obtained by the plurality of sensors which are installed in the mail common acceptance box, the integration control unit determines the mail common acceptance box as full, and assigns a spare delivery box instead of the mail common acceptance box to accept the mail.

3. The unmanned operation management apparatus of claim 1, wherein,
the integration control unit comprises a weight/size measurement unit configured to include the plurality of sensors which are respectively installed at the predetermined positions by a combination of row and column, and
the weight/size measurement unit measures a height of the mail, based on a sensing value, which is obtained by each of the plurality of sensors sensing the mail through the reflective plate, and a predetermined position value of each of the plurality of sensors.

4. The unmanned operation management apparatus of claim 1, wherein the integration control unit checks sensing values which are obtained by the plurality of sensors sensing the mail through the reflective plate, and when it is checked that a sensing value corresponds to a change from an on state to an off state and all sensing values subsequent thereto correspond to the off state, the integration control unit calculates, as a height value of the mail, a position value of a sensor for which a sensing value corresponds to the on state at a timing when the on state is changed to the off state.

5. The unmanned operation management apparatus of claim 1, wherein,
the integration control unit checks sensing values which are obtained by the plurality of sensors sensing the mail through the reflective plate,
in a case where it is checked that a sensing value corresponds to a change from an on state to an off state and there is a sensing value corresponding to the on state among sensing values subsequent thereto,
when a next sensing value corresponds to a change from an on (1) state to an off (1) state and a change from the off (1) state to an off (2) state, the integration control unit calculates, as a height value of the mail, a position value of a sensor for which a sensing value corresponds to the on (1) state,
when the next sensing value corresponds to a change from the on (1) state to the off (1) state, a change from the off (1) state to the off (2) state, a change from an on (2) state to the off (2) state, and a change from the off (2) state to an off (3) state, the integration control unit performs an addition operation on a position value of a sensor, for which a sensing value corresponds to the off (1) state, and a position value of a sensor for which a sensing value corresponds to the on (2) state, and calculates an average value of a plurality of addition result values as the height value of the mail, or
when the next sensing value corresponds to a change from the on (1) state to the off (1) state, a change from the off (1) state to the off (2) state, a change from the on (2) state to the off (2) state, a change from the off (2) state to an on (3) state, and a change from the on (3) state to the off (3) state, the integration control unit performs an addition operation on a position value of a sensor for which a sensing value corresponds to the on (2) state, a position value of a sensor for which a sensing value corresponds to the off (1) state, a position value of a sensor for which a sensing value corresponds to the on (3) state, and a position value of a sensor for which a sensing value corresponds to the off (2) state, and calculates an average value of a plurality of addition result values as the height value of the mail.

6. The unmanned operation management apparatus of claim 1, wherein,
when a value obtained by a sensor installed at a mail height limitation position corresponds to an on state, the integration control unit recognizes the mail as exceeding an acceptance limitation height,
when a value obtained by a sensor installed at a mail standard position corresponds to an off state, the integration control unit recognizes the mail as standard mail,
when the value obtained by the sensor installed at the mail standard position corresponds to the on state, the integration control unit recognizes the mail as nonstandard mail,
when a value obtained by a sensor installed at a parcel mail position corresponds to the on state, the integration control unit recognizes the mail as a parcel,
when the value obtained by the sensor installed at the parcel mail position corresponds to the off state and a value obtained by a sensor installed at an ordinary mail position corresponds to the on state, the integration control unit recognizes the mail as nonstandard ordinary mail, or
when it is determined based on the recognized result that the mail is mail which is acceptable through a slot, the integration control unit accepts the mail.

7. The unmanned operation management apparatus of claim 1, wherein the acceptance/delivery integrator operation management unit reflects a height of the mail, measured based on operation reference data for postage calculation, and delivery district information selected based on a receiver address and a mail address to calculate the postage.

8. The unmanned operation management apparatus of claim 1, wherein,
when the mail of the user is ordinary registration and registered parcel, the acceptance/delivery integrator operation management unit selects a transport means for delivering the mail,
when the mail of the user is ordinary parcel, the acceptance/delivery integrator operation management unit allows the user to select a delivery district, or
when the user is a member, the acceptance/delivery integrator operation management unit searches for and uses a registered address list for simplifying an input of mail acceptance information.

9. The unmanned operation management apparatus of claim 1, wherein,
when a settlement request is issued, the integration control unit transfers a settlement approval request to the acceptance/delivery integrator operation management unit,
when a cash balance of a cash settlement device is insufficient, a radio frequency (RF) settlement device settles for the other balance by RF card, and
the acceptance/delivery integrator operation management unit acquires and generates settlement information based on an identification (ID) corresponding to the RF card in a settlement operation using the RF card, settles for fee, and outputs the fee settlement result on a user screen.

10. The unmanned operation management apparatus of claim 1, wherein,
when a fee settlement is completed, the integration control unit outputs a label according to a kind of selected mail or a selected mail service, and
when the output of the label is completed, the integration control unit opens a door of the assigned mail common acceptance box so that the mail is inserted.

11. The unmanned operation management apparatus of claim 1, wherein,
the integration control unit acquires, by using a camera module, an image of the mail which is located in a weight and size measurement space, and calculates a face width and total length of the mail based on the acquired image of the mail, and
the acceptance/delivery integrator operation management unit calculates postage based on the calculated face width and total length of the mail and the mail acceptance information input by the user.

12. A method of controlling an unmanned operation management apparatus for accepting mail, the method comprising:
acquiring size information of mail by using a reflective plate and a plurality of sensors which are respectively installed at predetermined positions in parallel correspondence with the reflective plate;
calculating postage of the mail, based on the acquired size information; and
settling for the calculated postage of the mail, and allowing the mail to be inserted into an assigned mail common acceptance box.

13. The method of claim 12, wherein the acquiring comprises:
when a mail acceptance request is issued by a user, checking whether the mail common acceptance box is full;
when it is checked that the mail common acceptance box is not full, checking whether the mail is acceptable mail, based on weight and size measurement results of the mail; and
when it is checked that the mail is the acceptable mail, assigning the mail common acceptance box according to whether the mail common acceptance box is full.

14. The method of claim 12, wherein the acquiring comprises:
comparing the acquired size information and predetermined ordinary mail standard range information to determine whether the mail is ordinary standard mail; and
when it is determined that the mail is not the ordinary standard mail, checking whether the mail is acceptable mail which is based on a size of a slot.

15. The method of claim 12, wherein the acquiring comprises:
calculating a height of the mail which is located in a weight and size measurement space, based on information acquired by the plurality of sensors; and
calculating a top width and total length of the mail, based on image information of the mail acquired by a camera module.

16. The method of claim 12, further comprising:
when the mail is ordinary registration and registered parcel, selecting a transport means for delivering the mail;
when the mail is ordinary parcel, receiving a selection of a delivery district from the user; and
when the user is a member, using registered address information for simplifying an input of acceptance information in accepting the mail.

17. The method of claim 12, wherein the inserting comprises:
when a settlement request is issued and a cash balance of a cash settlement device is insufficient, settling for the other balance by radio frequency (RF) card by using an RF settlement device; and
acquiring and generating settlement information based on an identification (ID), corresponding to the RF card in a settlement operation using the RF card, to settle for fee.

18. The method of claim 12, further comprising:
checking a quantity of mail, which is accepted in the mail common acceptance box, and a full mail level value of the mail common acceptance box and; and
when it is determined that the mail common acceptance box is full, providing a collection work request to a worker terminal so that the worker performs a mail collection work.

19. The method of claim 12, wherein the inserting comprises:
when a fee settlement is completed, outputting a label according to a kind of selected mail or a selected mail service, and
when the output of the label is completed, opening a door of the assigned mail common acceptance box for inserting the mail.
